(19) United States
(12) Patent Application Publication
(10) Pub. No.: US 2003/0169494 A1
(43) Pub. Date: Sep. 11, 2003

(54) Optical loupes

(76) Inventors: Colin A. Porter, Box Hill North (AU); Simon M Meysztowicz, Burwood (AU)

Correspondence Address: David J Bates, Foley & Lardner, 777 East Wisconsin Avenue, Milwaukee, WI, 53202-5367, US

(21) Appl. No.: 10/258,111

(22) PCT Filed: Apr. 18, 2001
(86) PCT No.: PCT/AU01/00440

(30) Foreign Application Priority Data
Apr. 19, 2000 (AU) PQ 7018

(51) Int. Cl. G02C 1/00; G02B 23/00; G02B 27/02

(52) U.S. Cl. 359/409; 359/407; 359/408; 359/480; 351/158

(57) ABSTRACT

Optical loupes are disclosed which include eyepieces (21) having an ocular (40) and an objective (42). A transfer tube (44) is mounted for transferring light between the ocular (40) and objective (42). The objective (42) is arranged at an obtuse angle with respect to the ocular and the ocular and objective are in side by side relationship. The transfer tube includes a transfer means having mirrors for transferring light from the objective to the ocular. A light source (38) including a plurality of diodes (100) is mounted between the eyepieces (21) of illuminating a work area. The eyepieces (21) can be adjusted in the interpupliery direction by adjustment nobs (35) which engage in slots (34) on a support bar (22) which hold the eyepieces (21).

### FIELD OF THE INVENTION

This invention relates to optical loupes and in particular to optical loupes which allow a viewer to closely and conveniently observe an object which is being manipulated by the hands of the viewer below the normal level of sight. The invention is an improvement to the optical loupes disclosed in Australian patent 658460 and its counterpart U.S. Pat. No. 5,923,467 and European patent 614540.

The invention also relates to a light source which can be used in the optical loupes.

### DESCRIPTION OF THE PRIOR ART

The abovementioned patents disclosed optical loupes which address the problem of the need for a person to perform a manual task below the normal level of eyesight, such as a surgeon performing an operation. The aforesaid patents indicate that the head of the surgeon must be inclined to enable him to watch and co-ordinate his hands during an operation and during long operations even a slight inclination of the head can overwork the muscles of the neck, discomforting the surgeon and providing an additional unnecessary distraction.

The optical loupes disclosed in the abovementioned patent provide a solution to this problem and allow a surgeon to perform an operation whilst wearing the loupes with the surgeon looking generally ahead but, because of the loupes, having a field of vision which is below normal sight level.

In order to transfer light so that the field of vision is below normal sight level, at least one prism is employed within each eyepiece of the loupes.

### SUMMARY OF THE INVENTION

The object of the first aspect of the present invention is to provide optical loupes which provide further improvements to those disclosed in the abovementioned patents.

The invention may be said to reside in optical loupes, including:

a support means for wearing on a user's head, the support means having two eyepieces, so that when the loupes are worn by a user, the eyepieces are disposed in front of the user's eyes, each eyepiece having:

(a) an objective having an objective axis;

(b) an ocular having an ocular axis, the ocular and the ocular-axis being arranged at an angle with respect to the objective and the objective axis, the objective and the ocular being arranged in side by side relationship; and

(c) light transfer means for transferring light from the objective to the ocular.

The loupes according to the present invention can be made smaller than loupes made in accordance with the prior art teachings because of the location of the ocular and objective in side by side relationship. Furthermore, because the ocular and objective are arranged in side by side relationship and therefore the light path packaging is effectively in three dimensions, rather than in a two dimensional plane as in the prior art, the load on a wearer's nose when the loupes are worn is reduced, because the moment of inertia of the optical loupe around the nose support is substantially smaller than in conventional designs of equal optical parameters.

In the preferred embodiment of the invention the light transfer means includes a plurality of mirrors for transferring light from the objective to the ocular. In the most preferred embodiment the light transfer means comprises only mirrors for transferring the light.

By using mirrors instead of a prism the weight of the eyepieces is reduced and the mirror configuration can therefore be made as large as practicable. By avoiding the use of prisms, the effective separation of the objective and any eyepiece lenses is increased by a factor approximately equal to the refractive index of the prism without increasing the overall physical size of the eyepiece. This allows an objective lens of significantly longer focal length to be used which provides greater depth of field, more consistent working distances for different magnifications and generally better image quality. Furthermore, the separation of a first mirror in the objective and a second mirror towards which light is reflected by the first mirror can be increased arbitrarily, within limits of the required size of the eyepieces, any objective lens is positioned well away from the eyepiece optics. This allows larger than normal lenses to be used thereby increasing the available field of view. Furthermore, since a prism relies upon total internal reflection to reflect light, the prior art loupes are limited to angles of reflection greater than the critical angle of the prism material. Since a mirror can reflect light at any angle by appropriate adjustment of its position, there is no such limitation in the loupes of the present invention.

Preferably the angle is an obtuse angle of, for example, 135°.

Preferably the ocular axis and objective axis are in planes spaced apart in the interpupillary direction when the loupes are worn by a user

Preferably the plurality of mirrors includes at least a first mirror in the objective for reflecting light in a first direction, a second mirror for receiving light from the first mirror and reflecting the light generally in the interpupillary direction, a third mirror for receiving light from the second mirror, and a fourth mirror in the ocular for receiving light from the third mirror and reflecting the light into the ocular.

Preferably the second and third mirror form a roof structure for flipping an image from side to side, and wherein the objective includes an objective lens so that an image which is inverted by the objective lens is flipped side by side by the second and third mirrors and upside-down by reflection from the first mirror to the fourth mirror.

In other embodiments of the invention the plurality of mirrors may include two, six or eight mirrors.

Preferably the spaced apart planes are substantially parallel vertical planes.

Preferably the ocular includes an ocular lens remote from the fourth mirror.

Preferably the objective includes an objective lens remote from the first mirror.

Preferably the ocular further includes an ocular housing tube which supports the ocular lens and the fourth mirror.

Preferably the objective further includes an objective housing tube which supports the objective lens and the first mirror.

Preferably the second and third mirrors are arranged in a transverse tube housing communicating with the ocular tube housing and the objective tube housing.

Preferably the objective tube housing, ocular tube housing and transverse tube housing are integrally coupled together to form an integral eyepiece housing.

Preferably the ocular tube housing includes an insert tube connected to the ocular tube housing which supports the ocular lens, the insert tube having an end stop arranged between the ocular lens and the fourth mirror.

Preferably an end cap is arranged on the insert tube, the end cap having an annular flange, the insert having a shoulder and wherein the ocular lens is arranged between the annular flange and the shoulder.

Preferably the support means is a frame having a pair of arms and a nose support.

Preferably a light source is mounted to the frame between the eyepieces.

Preferably the light source comprises an array of light emitting diodes.

Preferably the light source includes a power supply for supplying power to the diodes.

Preferably the power supply comprises a battery.

Preferably the array of light emitting diodes comprises a central diode and at least six diodes surrounding the central diode.

Preferably the diodes have individual lenses which are spaced from the diode junction of the diodes.

In one embodiment of the invention the lenses associated with the diodes which surround the central diode are tilted so as to face a central axis of the diode array to direct light from the diodes which surround the central diode towards the light beam emitted by the central diode.

In a second embodiment of the invention the lens associated with the diodes which surround the central diode are displaced towards the lens associated with the central diode.

Preferably the ocular lens includes two lenses, and a spacer ring is provided between the two lenses for spacing the two lenses slightly apart.

The present invention may also be said to reside in an eyepiece for optical loupes, including:

(a) an objective having an objective axis;

(b) an ocular having an ocular axis, the ocular and the ocular axis being arranged at an angle with respect to the objective and the objective axis, the objective and the ocular being arranged in side by side relationship; and

(c) light transfer means for transferring light from the objective to the ocular, the light transfer means comprising a plurality of mirrors for transferring light from the objective to the ocular.

Preferably the ocular axis and objective axis are in spaced apart planes.

Preferably the angle is an obtuse angle of, for example, 135°.

Preferably the plurality of mirrors includes at least a first mirror in the objective for reflecting light in a first direction, a second mirror for receiving light from the first mirror, a third mirror for receiving light from the second mirror, and a fourth mirror in the ocular for receiving light from the third mirror and reflecting the light into the ocular.

Preferably the second and third mirror form a roof structure for flipping an image from side to side, and wherein the objective includes an objective lens so that an image which is inverted by the objective lens is flipped side by side by the second and third mirrors and upside-down by reflection from the first mirror to the fourth mirror.

In other embodiments of the invention the plurality of mirrors may include two, four or six mirrors. Preferably the spaced apart vertical planes are substantially parallel vertical planes.

Preferably the ocular includes an ocular lens remote from the fourth mirror.

Preferably the objective includes an objective lens remote from the first mirror.

Preferably the ocular further includes an ocular housing tube which supports the ocular lens and the fourth mirror.

Preferably the objective further includes an objective housing tube which supports the objective lens and the first mirror.

Preferably the second and third mirrors are arranged in a transverse tube housing communicating with the ocular tube housing and the objective tube housing.

Preferably the objective tube housing, ocular tube housing and transverse tube housing are integrally coupled together to form an integral eyepiece housing.

Preferably the ocular tube housing includes an insert tube connected to the ocular tube housing which supports the ocular lens, the insert tube having an end stop arranged between the ocular lens and the fourth mirror.

Preferably an end cap is arranged on the insert tube, the end cap having an annular flange, the insert having a shoulder and wherein the ocular lens is arranged between the annular flange and the shoulder.

Preferably the ocular lens includes two lenses, and a spacer ring is provided between the two lenses for spacing the two lenses slightly apart.

A second aspect of the invention concerns a light source which can be used with optical loupes but which also has other applications.

Conventionally, light sources used with optical loupes comprise lamps or like arrangements which are generally bulky and require a large battery to power. In general, when a surgeon uses optical loupes, the light source connected to the loupes is powered by a cable which extends from the light source usually behind the surgeon to a battery pack which is carried on the surgeons belt or otherwise suitably connected to the surgeon. In view of the nature of the light source the power packs generally do not provide a significant time period over which the light source can be powered and it is usually necessary to change power packs a number of times during the course of a lengthy operation.

A second aspect of the invention is concerned with providing a light source which is relatively small and does not require a significant amount of power to operate thereby decreasing the size of a battery which is required whilst at the same time increasing the period between which batteries need to be changed to power the light source.

This aspect of the invention may be said to reside in a light source including;

an array of light emitting diodes;

an array of lenses spaced from the light emitting surface of the light emitting diodes for directing light emitted by the light emitting diodes into a field of view.

According to this aspect of the invention, the power required to operate the light emitting diodes is very small thereby requiring only a small battery to operate the diodes to emit light. Furthermore, the amount of power required means that even a small battery will have a long lifetime thereby increasing the time period between which batteries need to be changed to provide continuous power to the light source.

Preferably the light emitting diodes emit white light.

Preferably the array of light emitting diodes comprises a central diode and a plurality of diodes surrounding the central diode.

Preferably the plurality of diodes surrounding the central diode comprises six diodes.

Preferably the array of lenses includes a separate lens for each diode in the array of light emitting diodes.

In one embodiment of the invention the lenses associated with the diodes surrounding the central diode are tilted towards a central axis of the array of lenses to direct light from the diodes surrounding the central diode towards the light beam emitted by the central diode.

In another embodiment of the invention the lenses associated with the diodes surrounding the central diode are displaced towards the lens associated with the central diode so as to direct light towards the light beam of the central diode.

A further aspect of the invention may be said to reside in optical loupes, including:

a frame for wearing on a user's head, the frame supporting two eyepieces so that when the loupes are worn by a user, the eyepieces are disposed in front of a user's eye, each eyepiece having;

an objective, and an ocular arranged at an angle with respect to the objective, so that when looking through the eyepieces a field of view is provided different to that which would be provided if looking only through the ocular;

a light source coupled to the frame for illuminating the field of view of the loupes, the light source including an array of light emitting diodes.

Preferably the array of light emitting diodes have an array of lenses spaced from the light emitting surface of the light emitting diodes.

In a normal light emitting diode the lens is applied directly to the end surface of the light emitting diode from which light is emitted. According to the present invention, by removing the lens the light appears to come from a more point like source and is spread over a wider angle. To create a more suitable narrow angle beam, the lenses are set at a distance from the light emitting surface of the diodes with the separation between the lens array and the light emitting diodes being selected to provide the required optical beam profile. Thus, according to the present invention a light source which provides adequate illumination over a required area can be achieved with a small and relatively long lasting power supply.

Furthermore, in prior art light sources particularly used in loupes, a significant amount of heat is generated by the light source. Since the loupes are worn very close to the user's face the heat generated can make it extremely uncomfortable for the user. By using the light emitting diode array of the present invention, the amount of heat generated is considerably less and since most of the heat is actually produced by a current limiting resistor which can be place at a significant distance from the light emitting diode itself, the light source is not subject to the same problems associated with heat generation as prior art light sources used in conjunction with loupes.

The colour of light produced by conventional light sources is typically quite yellow in colour whereas the light emitting diodes of the present invention can produce white light or different colours which when combine produce white light. If a slightly different colour is required then individual light emitting diode currents can be adjusted to provide a virtually continuous colour variation from red through to blue.

Furtherstill, conventional light sources used with loupes contain only a single lamp. If the lamp fails during an operation, all surgical work must cease until a replacement lamp is fitted. This may effect the alignment of the loupe on the surgeon's head. The present invention overcomes this problem by the light emitting diode array which, apart from its much greater life expectancy, also continues to function at a reasonable light level if one light emitting diode should fail, thereby allowing the surgery to continue.

Preferably the array of light emitting diodes have an array of lenses spaced from the light emitting surface of the light emitting diodes.

Preferably the array of light emitting diodes comprises a central diode and a plurality of diodes surrounding the central diode.

Preferably the plurality of diodes surrounding the central diode comprises six diodes.

Preferably the array of lenses includes a separate lens for each diode in the light emitting diode.

In one embodiment of the invention the lenses associated with the diodes surrounding the central diode are tilted towards a central axis of the array of lenses to direct light from the diodes surrounding the central diode towards the light beam emitted by the central diode.

In another embodiment of the invention the lenses associated with the diodes surrounding the central diode are displaced towards the lens associated with the central diode so as to direct light towards the light beam of the central diode.

The invention may also be said to reside in optical loupes, including;

a frame for wearing on a user's head, the frame supporting two eyepieces so that when the loupes are worn by a user, the eyepieces are disposed in front of a user's eye;

distance adjusting means for adjusting the distance between the eyepieces in the interpupillary direction, the distance adjusting means including;

(a) a slider coupled to at least one of the eyepieces;

(b) an adjustment knob coupled to the slider;

(c) a pinion gear fixed relative to the knob for rotation with the knob;

(d) a rack engaged with the pinion gear and fixed relative to the frame and, wherein when the knob is rotated the pinion is also rotated so that engagement between the pinion and rack causes movement of the knob, pinion and slider relative to the frame in the interpupillary direction so as to enable adjustment of said at least one eyepiece in the interpupillary direction.

Preferably a locking screw is supported in the pinion and in engagement with the slider so as to clamp the slider relative to the frame and selectively release the slider from the frame to enable the slider to move relative to the frame to adjust the interpupillary distance between the eyepieces.

Preferably the frame includes an interpupillary adjustment bar having at least one slot, the locking screw projecting through the slot and into the slider arranged below the slot so as to couple the adjustment knob and the pinion gear to the slider.

Preferably a screw thread is provided between the shaft of the screw and a bore in the slider for coupling the locking screw to the slider.

Preferably upon locking rotation of the locking screw, the slider is drawn against the bar to lock the slider fixed relative to the frame and upon loosening of the locking screw the slider is able to slide relative to the bar.

Preferably each of the eyepieces includes a said adjusting means.

A further aspect of the invention concerns the manner in which the eyepieces of an optical instrument are designed and arranged so as to minimise eyestrain.

This aspect of the invention may be said to reside in an optical instrument including;

a first eyepiece and a second eyepiece through which a user of the instrument will look in order to observe an object;

the first and second eyepieces including an ocular each having an axis; and

the axes of the oculars being arranged such that the axes converge towards one another from a spacing of greatest dimension adjacent an end of the ocular through which a user looks to observe the object, towards an end of the ocular remote from the end adjacent the user, the amount of convergence being substantially the same as the convergence of the field of view of a user observing an object spaced from the observer by a distance of about 1 m.

The arrangement of the oculars so that they converge in the manner described above rather than being parallel results in the user looking through the ocular in accordance with the normal amount of convergence of the eyes which would occur when a user looks at an object. Because the user's eyes are converged at the usual amount of convergence little or no eye strain is produced and furthermore, it is much easier for the user to look through the oculars which converge in this manner because the convergence is the same as that of a user's normal line of sight when observing an object. If the oculars are arranged substantially parallel with respect to one another, as is usual for optical instruments, the user's eyes must take up a position having generally no convergence which is not usual and therefore produces eye strain. Furthermore, because the user is required to make his or her eyes line up with horizontal axis so the user can look through the oculars it is often difficult for the user to form and hold a field of view through the oculars of optical instruments.

Preferably the angle of convergence is between 2° and 5° and most preferably about 3°.

Preferably the optical instruments includes an objective having an objective axis. In the preferred embodiment of the present invention in which the optical instruments is in the form of optical loupes, the axis of the objective is preferably arranged at an angle with respect to the axis of the ocular.

Most preferably the objective and ocular are arranged in side by side relationship.

Preferably the optical instrument includes light transfer means for transferring light from the objective to the ocular.

Most preferably the light transfer means comprises mirrors.

Preferably the objectives are arranged at an angle with respect to one another by rotating each eyepiece about the ocular axis so as to cause the objective axes to converge to a point coincident with the field of view which is desired through the optical instrument.

Preferably a transverse axis extends between the ocular and the objective along which light is reflected so as to transfer light from the objective to the ocular, the transfer axis including at least two mirrors, and the two mirrors being rotated slightly in order to cancel out any rotation of the image caused by rotation of the eyepieces about the ocular axis so as to cause the objectives to converge towards one another.

### BRIEF DESCRIPTION OF THE DRAWINGS

Preferred embodiments of the invention will be described, by way of example, with reference to the accompanying drawings in which;

FIG. 1 is a perspective view of optical loupes embodying the invention;

FIG. 1A is a view along the line E-E of FIG. 1;

FIG. 1B is a view along the line F-F of FIG. 1;

FIG. 2 is a perspective view of an eyepiece used in the loupes of FIG. 1;

FIG. 3 is a view of a lens and mirror arrangement used in the eyepiece of FIG. 2;

FIG. 4 is a view from the front of one of the eyepieces used in FIG. 1;

FIG. 5 is a view along the line BB of FIG. 4;

FIG. 6 is a view along the line AA of FIG. 4;

FIG. 6A is a diagram used to illustrate the angular orientation of eyepieces in the loupes of the preferred embodiment, looking down on the loupes from above when the loupes are worn by a user;

FIG. 6B is a diagram also assisting in showing the angular orientation of the loupes looking from the front when the loupes are worn by a user;

FIG. 7 is a schematic view of a light source as used in one embodiment of the invention;

FIG. 8 is a side view of the light source of FIG. 7;

FIG. 9 is a schematic view of a modified form of the light source of FIG. 7;

FIG. 10 is a side view of the light source of FIG. 9;

FIG. 11 is a schematic view of a further modified form of the light source of FIG. 7;

FIG. 12 is a side view of the light source of FIG. 11;

FIG. 13 is a side view of a light source in accordance with FIGS. 7-12;

FIG. 14 is a view along the lines C-C of FIG. 13.

FIG. 15 is a schematic view along of another embodiment of the invention;

FIG. 16 is a view along the line D-D of FIG. 15;

FIGS. 17 and 18 are schematic views of further embodiments.

### DETAILED DESCRIPTION OF THE PREFERRED EMBODIMENTS

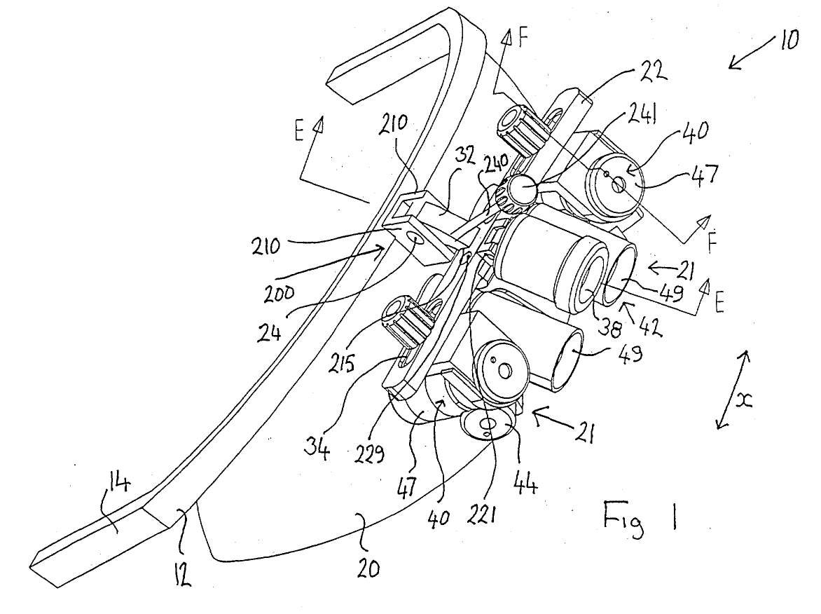

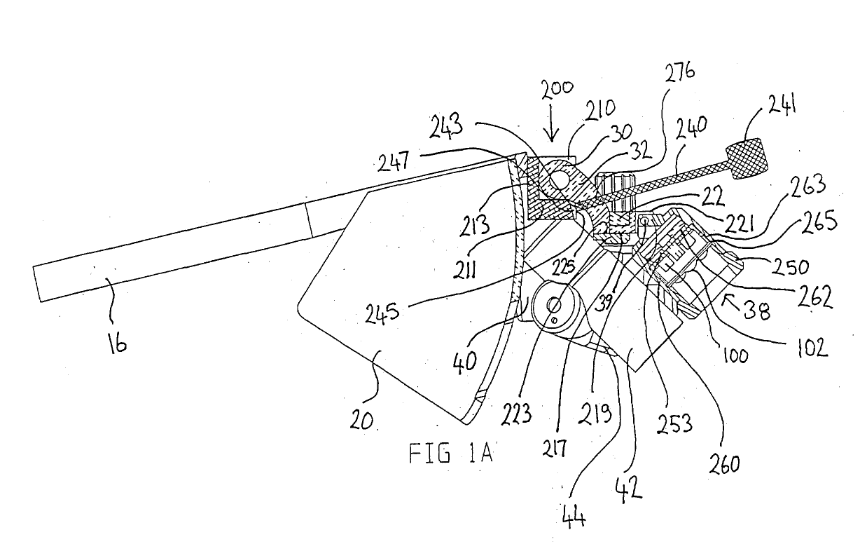

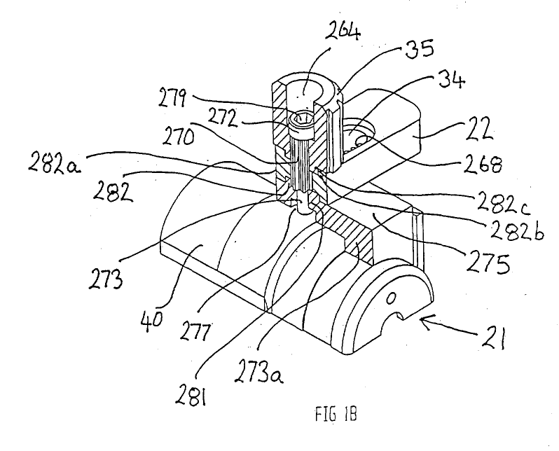

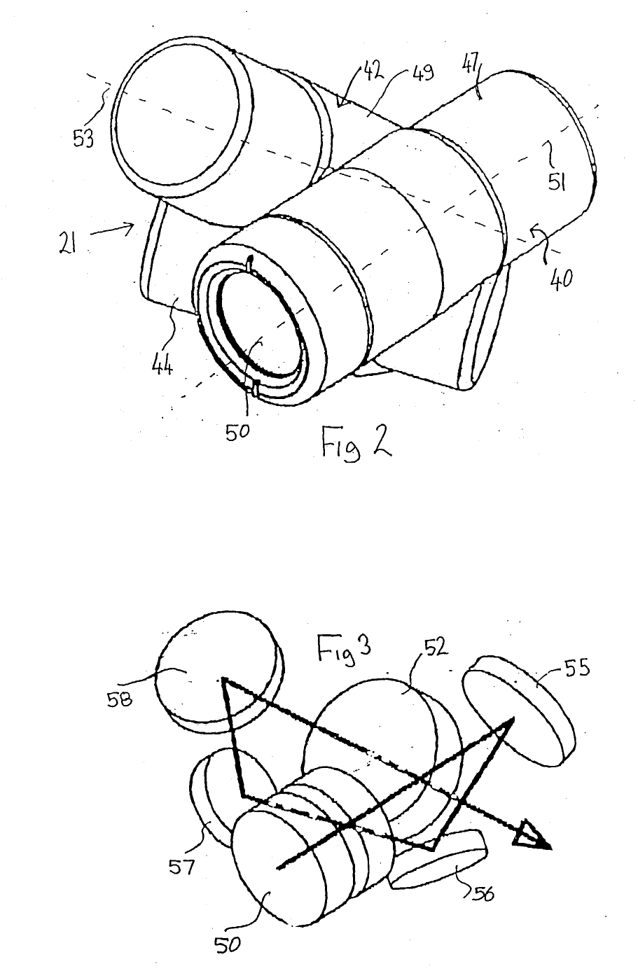

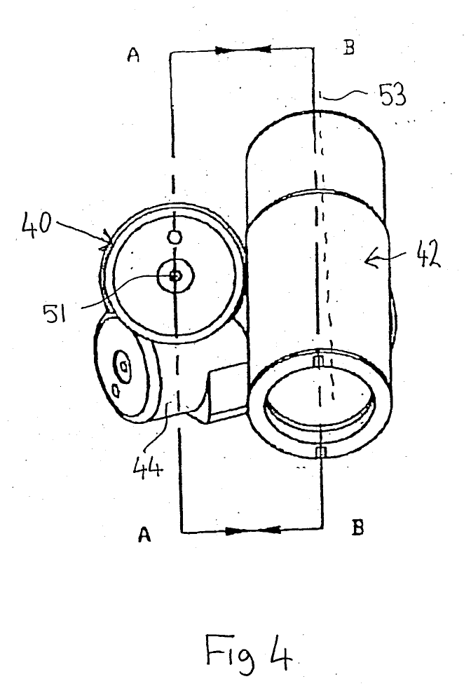

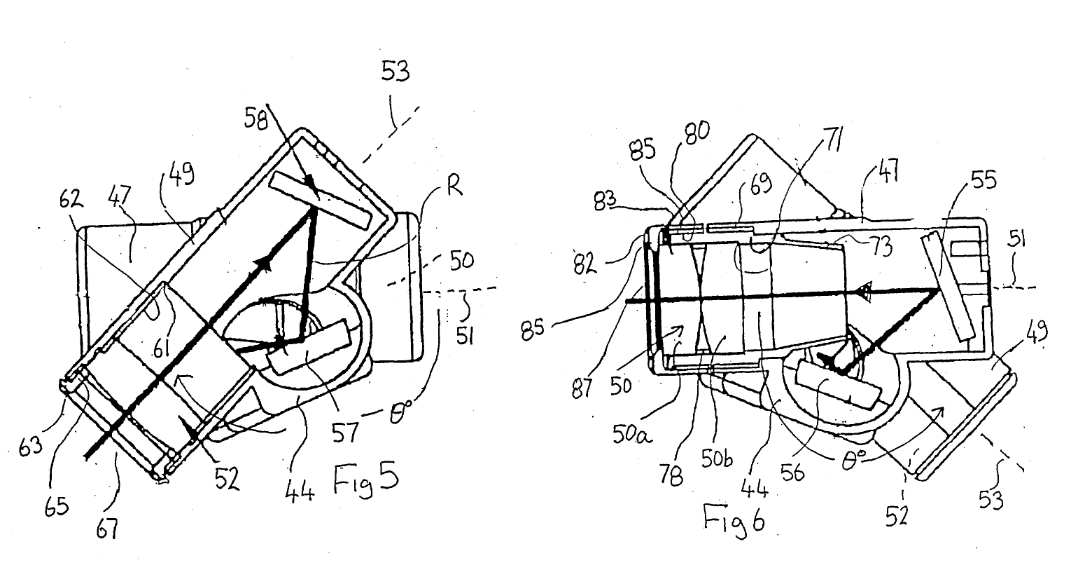

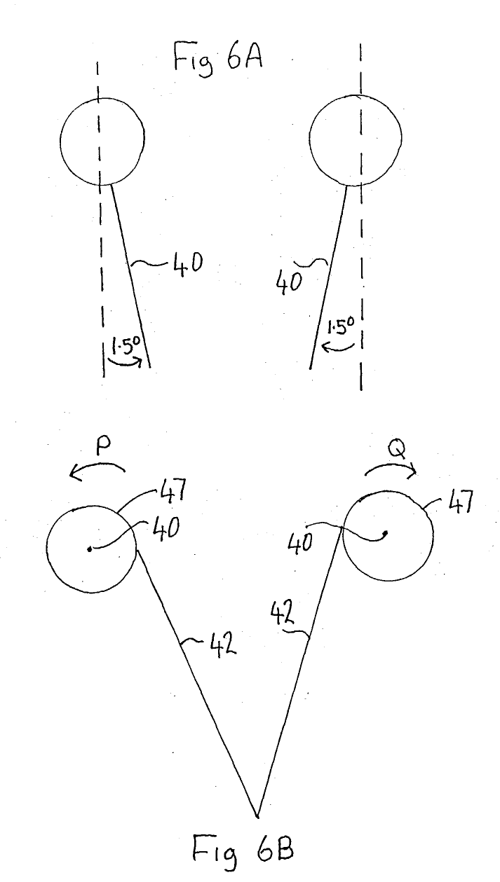

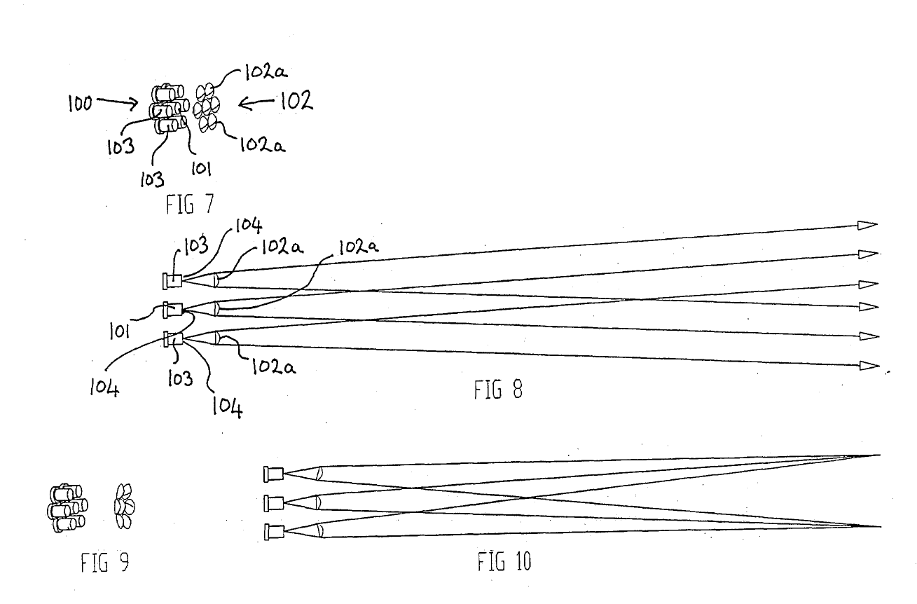

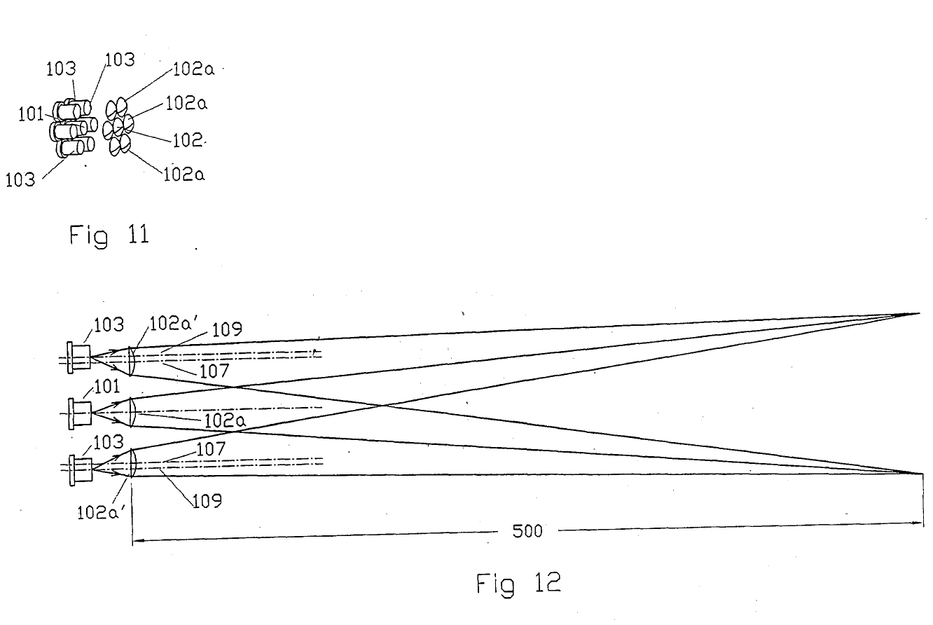

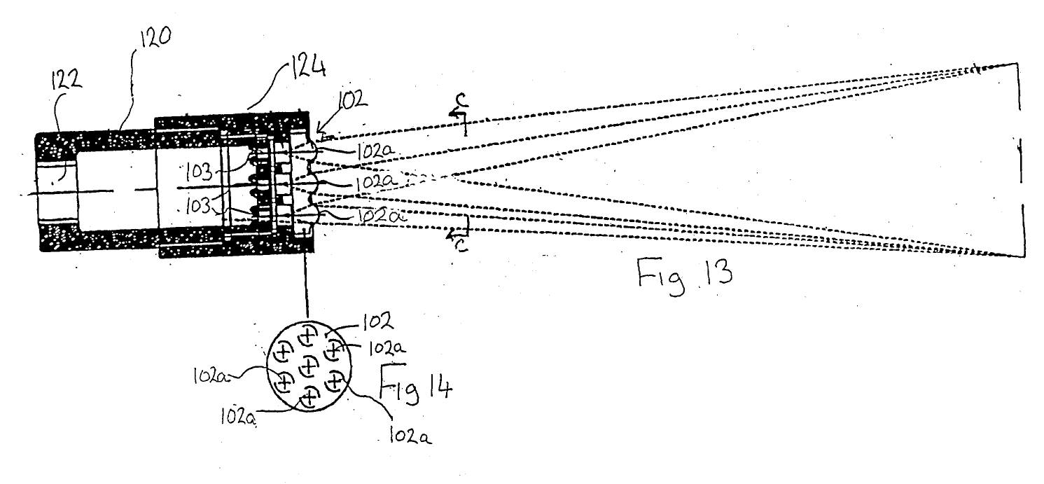

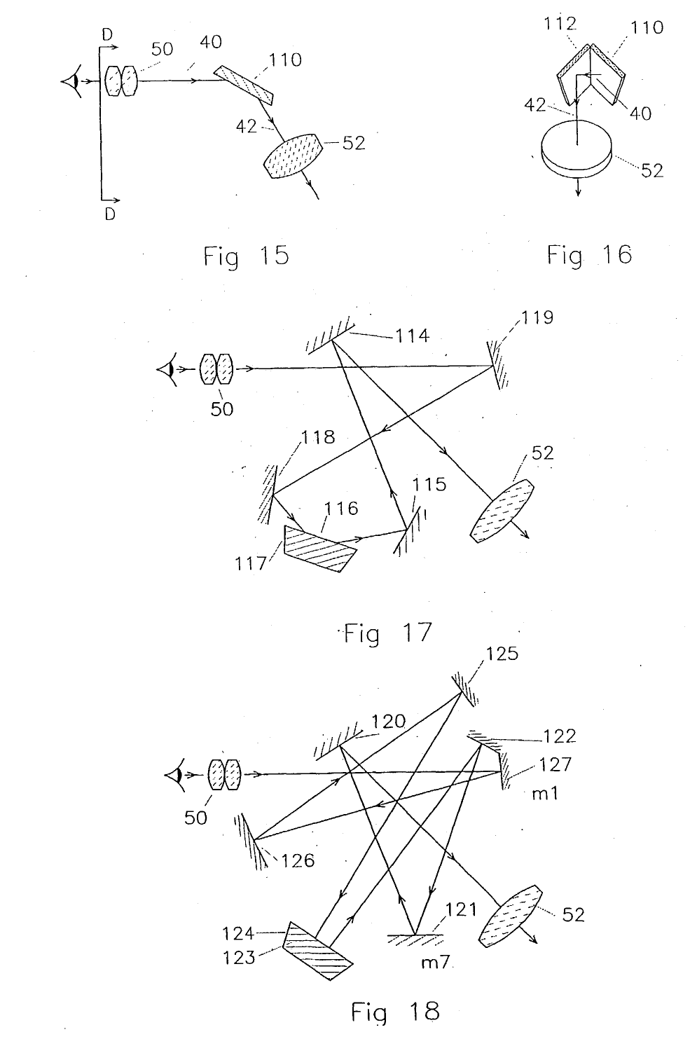

FIGS. 1 and 1A show optical loupes for use by a surgeon during the performance of an operation. The loupes 10 comprise a spectacle frame 12 which includes arms 14 and 16 which can engage the side of user's head and the user's ears and a nose piece 18 which rests on the bridge of a user's nose so that the loupes 10 are worn in the same manner as spectacles. The frame 12 may include a clear plastic or glass lens or shield 20. As best shown in FIGS. 1 and 1A, an attachment bracket 200 is secured onto the shield 20 or the frame 12 by any suitable means such as small bolts, adhesive or the like. The attachment bracket 200 has two spaced apart flanges 210 which define a channel or trough therebetween, a base wall 211 and rear wall 213 (see FIG. 1A).

A dislocating arm 32 is pivotally connected to the bracket 200 by a pivot pin 24 which passes through a generally barrel shaped cam 30 arranged at the end of the dislocating arm 32. The pivot pin 24 is received in flanges 210 of the bracket 200. A support bar 22 is connected to the dislocating arm 32 and extends laterally across the arm 32 in front of the shield 20. As best shown in FIG. 1A the bar 22 has a cut out 215 to accommodate the arm 32. The bar 22 has a cut out 217 which receives a support bracket 219 which includes a lug 221. A bottom plate 223 is located flush with bottom end 225 of the arm 32 so that the support bracket 219 is sandwiched between the bar 22 and the plate 223. The plate 223 may be secured to the bar by nuts or bolts 229 best show in FIG. 1. The bar supports two eye pieces 21, which each include an ocular 40 and an objective 42, in the manner which will be described in more detail hereinafter. The eyepieces 21 are positioned in front of the shield 20 and are positioned where a person wearing the loupes 10 can see through the eyepieces 21 to observe a work area.

The bar 22 and therefor the eyepieces 21 are mounted for pivotal movement on the dislocating arm 32 so that when the dislocating arm 32 pivots on pivot pin 24 the eyepieces 21 can be moved from the position shown in FIGS. 1 and 1A to a position removed from the shield 20 and out of the field of view of a person wearing the loupes. When the arm 32 is pivoted about the pivot pin 24 friction between the cam 30 and bracket 200 and pin 24 can hold the dislocating arm 32 in the adjusted position against the weight of the bar 22 and eyepieces 21. The cam 30 has increased contact or pressure on base 211 and wall 213 of the bracket 200 to greatly increase the friction at 90° rotation of the arm 32 so that the eyepieces 21 may be held in an adjusted position whilst a surgeon is walking or generally imparting greater than gravitational loads on the eyepieces 21.

The adjusting bar 22 extends in the interpupillary direction X of the loupes, and as previously mentioned supports the eyepieces 21 which will be described in more detail with reference to FIGS. 2 to 6.

A light source 38 is coupled to the support bracket 219 by a pin 39 which extends between the lugs 221.

The light source 38 comprises a cylindrical housing 250 which is provided with a rear bracket 252 which engages the pin 39 to mount the light source to the bracket 219. The housing 250 contains a circuit board 253 on which light emitting diodes 100 are provided. It should be understood that various arrangements of the light emitting diodes 100 which can be an embodiment the invention will be described hereinafter with reference to FIGS. 7 to 14. A dish shaped support 260 having a base 262 and a peripheral side wall 263 supports the diodes 100 which are mounted on the circuit board 252 by the diodes passing through holes cut in the base 262 of the dish shaped support. A lens array 102 (which will also be described with more detail in FIG. 7 to 14) is inserted into the housing 250 and sits on rim 265 of the support 260 so as to space the lens array 102 a predetermined distance from the diodes 100.

The housing 250 is fixed in position on the bracket 219 so that it directs light to the region which is to be observed when a surgeon looks through the loupes. As best shown in FIGS. 1 and 1A the housing 250 is generally parallel with objective 42 of the eyepieces 21 which will be described in more detail hereinafter.

A dislocating lever 240 having a nob 241 at its free end is provided with a screw thread and is mounted in a screw threaded bore 276 which passes through the arm 32. The end 243 of the lever 240 abuts against end surface 245 of the base 211 of the bracket 200. The base 211 of the bracket 200 accommodates a magnet 247 which can be located in a suitable recess formed in the base 211 or merely be connected to the base 211 so that it forms the end 243 of the base 211 so that by magnetic attraction, the magnet holds the ends 243 of the lever 240 in place as shown in FIG. 1A.

By rotating the lever 240 about its longitudinal axis the screw threaded engagement between the bore 276 in the arm 32 and the screw thread on the lever 240 will cause the arm 32 to move into and out of the bore 276 and pivot the arm 32 slightly about pivot pin 24 in the direction of double headed arrow A in FIG. 1A. This can slightly adjust the position of the eyepieces 21 in the pivotal direction of the arm 32 so as to place them in the desired position to suit the surgeons field of view and enable the surgeon to easily look through the eyepieces 21. If the surgeon wishes to tilt the eyepieces 21 so that they are completely out of the field of view the surgeon need only touch the lever 240 and push it upwardly in the direction of arrow B against the magnetic attraction between the lever 240 and the magnet 247 so that the bar 22 and also the eyepieces 21 is pivoted in the direction of arrow B out of the field of view of the surgeon. When the surgeon again desires to place the eyepieces 21 back in his field of view to continue work the lever 240 can moved in a direction opposite arrow B to return the eyepieces 21 to the position shown in FIGS. 1 and 1A and with the magnetic attraction between the end 243 of the lever 240 and the magnet 247 holding the bar 22 and therefore the eyepieces 21 in position as shown in FIGS. 1 and 1A.

The lever 240 can be sterilised and located in place in the loupes so that a surgeon is able to grip the lever 240 and pivot the loupes out of his filed of view should that be necessary or required without fear of contamination and therefore without the need to change his surgical gloves. Thus, the surgeon can move eyepieces 21 into and out of his filed of view should that be necessary during the course of an operation without the need for removing his gloves and fear of contamination.

With reference to FIG. 1 and FIG. 1B, the bar 22 supports the eyepieces 21 which are mentioned above so that the eyepieces 21 can be positioned in front of a surgeon's eye. The mounting of the right hand eyepiece in FIG. 1 will be described with reference to FIG. 1 and FIG. 1B. The mounting of the other eyepiece 21 is identical but a mirror image to the eyepiece 21. As shown in FIGS. 1 and 1B, the bar 22 has slot 34 and an adjustment knob 35 which has a hollow interior 264 is supported on bar 22 and has a pinion gear 270 fixed within the interior 264 by adhesive or any other suitable manner. The pinion gear 264 is in meshing engagement with a pinion gear rack 268 formed on an inner surface of the slot 34. A locking cap screw 272 passes through the pinion 270 and has a screw threaded shaft 273. The slider 275 has a stepped section 282 which receive the bar 22. The slider 275 is fixed to the eyepiece 21 by having a surface 273a which matches the contour of the outer surface of the eyepiece 21 and is secured to the eyepiece 21 by adhesive, bolts or the like. As can also be best seen in FIG. 1B the slider 275 has a stepped section 282 which nests in a correspondingly shaped groove or cut-out 282a in the bar 22. Similarly, the nob 35 has a stepped portion 282b which sits in a recess or groove 282c which is formed on the upper periphery of the slot 34. Thus, the nob 35 as well as the slider 275 (and therefore the eyepiece 21), is able to slide relative to the bar 22 by the portions 282 and 282b sliding in the grooves 282a and 282c. The screw threaded shaft 273 passes through a slot 273a which is generally coterminous with the slot 34. A nut (not shown) is accommodated in recess 277 formed on the underside of the slider 275. The screw threaded shaft 273 screws into the nut (not shown) so as to enable the screw 272 to be tighten to clamp the slider 275 to the support bar 22.

In order to adjust the interpupillary distance between the eyepieces 21, locking cap screw 272 is loosened by an allen-key which can be engaged in recess 279 so as to reduce the clamping effect between bar 22 and the slider 275 in the region of the section 282 and section 282b, and the grooves 282a and 282c. The knob 35 can then be rotated. As the knob 35 is rotated the pinion 270 is also rotated and engagement of the pinion 270 with the rack 268 causes the knob 35 and also the slider 275 to move in the interpupillary direction of double headed arrow X in FIG. 1 (dependent on the direction of rotation of the knob 35) so that the slider 275 can slide relative to the bar 22 to change the interpupillary distance between the eyepieces 21 to match the interpupillary distance between the eyes of a user. When the distance has been correctly adjusted the cap screw 272 is retightened by screwing into the nut (not shown) in recess 277 so as to pull the slider 275 hard against the bar 22 in the region of the sections 282, 282a, 282c so as to lock the slider 275 and therefore the eyepiece 21 in the required position. This allows very precise setting of the interpupillary distance between the eyepieces 21.

The eyepieces 21 are identical and arranged in mirror image with one another as is clearly shown in FIG. 1. As shown in FIG. 2 the eyepieces 21 comprise the ocular 40, the objective 42 and a transverse tube 44 which communicates with both the ocular 40 and objective 42. As can be clearly seen in FIG. 1 the eyepieces 21 are arranged so that the objectives 42 are on the inside of each of the oculars 40. The ocular 40 includes an ocular tube 47 which is integral with the transverse tube 44 and the objective 42 includes an objective tube 49 which is also integral with the transverse tube 44. The ocular tube 47, the transverse tube 44 and the objective tube 49 are formed as an integral unit from plastics or metal material to form an eyepiece housing. The ocular 40 has an ocular lens 50 and defines an ocular axis 51 shown in FIG. 2. The objective 42 has an objective lens 51 (not shown in FIG. 2) and defines an objective axis 53. As is shown in FIG. 2, the objective 42 is inclined with respect to the ocular 40 so as to form an obtuse angle θ° (see FIGS. 5 and 6), of for example 135°, with respect to the ocular 40. The ocular 40 and objective 42 are in side by side relationship rather than being optically arranged one after the other, and the axes 51 and 53 are also side by side and spaced apart from one another in the interpupillary direction X of FIG. 1 so as to be in separate spaced apart vertical planes. The side by side relationship of the ocular 40 and objective 42 and the separate vertical planes which contain the axes 51 and 53 can be best seen from FIG. 4 which is a view of the right hand (from the wearer's perspective) eyepiece 21 of FIG. 1 from the front of the loupes shown in FIG. 1. For ease of illustration it should be understood that the stem 35′ and block 36 and screw threaded nut 37 are not shown in FIGS. 2 to 6.

The ocular 40, objective 42 and transverse tube 44 contain mirrors so that light is transferred from the objective 42 to the ocular 40 so that it can be viewed by a user wearing the loupes through the oculars 40 of the eyepieces 21. FIG. 3 shows the ocular lens 50, the objective lens 52 and mirrors 55, 56, 57 and 58 in free space without the eyepiece housing formed by the ocular tube 47, objective tube 49 and transverse tube 44 for the purposes of illustrating light transfer from the objective 42 to the ocular 40. To simplify the description of the mirror configuration shown in FIG. 3 it will be convenient to describe the device function as though light is travelling through the eyepiece in the opposite direction to that intended by its use. As such, the optical axis passing through the ocular lens 50 is reflected by a mirror 55 downwardly through an angle less than 90° whereupon it is subsequently reflected by mirror 56 both vertically and horizontally towards mirror 57. The horizontal component of this reflection is in the interpupillary direction of the eyepieces 21 so as to effectively transfer light from the ocular 40 to the objective 42. Light from mirror 56 is reflected by mirror 57 vertically to mirror 58. Mirror 58 reflects the light through objective lens 52. Obviously, when the loupes are being used light travels in the opposite direction as shown in FIG. 3 and described above because the viewer will be viewing light entering the objective lens 52 and being reflected up to the ocular lens 50 for viewing by the user.

The angle between mirrors 56 and 57 is set at 90° and, as noted above, the reflected light from mirror 57 is in a vertical plane. The light reflected by a mirror 58 is also in that vertical plane. The angle at which mirror 58 is set is such that the vertical plane containing the optical axis from mirror 57 and 58 and from mirror 58 to objective lens 52 is parallel to the vertical plane containing the optical axis from ocular lens 50 to mirror 55 and from mirror 55 to mirror 56. Depending upon the vertical angles of the reflection chosen for all four mirrors, the optical axis through the objective lens 52 can be made to form any angle with the optical axis passing through the ocular lens 50 and not just 0°.

The mirror and lens arrangement shown in FIG. 3 is shown in-situ in the cross-sectional drawings forming FIGS. 5 and 6. Firstly with reference to FIG. 5 the objective tube 49 has an internal shoulder 61 against which sits a tubular spacer 62 which abuts and positions objective lens 52. The objective lens 52 is a cemented doublet lens formed from two lenses adhered together in back to back relationship so as to have the appearance of a single lens shown in FIG. 5. An end cap 63 having a flange 65 carrying a screw thread is screw threaded into the tube 49 behind the lens 52 so as to hold the lens 52 securely in place. The end cap 63 has an open end 67 so that light can pass through the end cap 63 into the objective tube 49. The mirror 58 is arranged at the end of the objective tube 49 remote from the lens 52 as shown in FIG. 5. The transverse tube 44, is arranged below the tube 49 and opens into the tube 49 so that light reflected by the mirror 58 is received by the mirror 57 supported at one end of the transverse tube 44, as shown by the light ray marked R in FIG. 5. The arrow head on the ray R in FIG. 5 shows the direction of light travel when the loupes are in use from a field of view below the objective tube 49.

FIG. 6 shows a cross-sectional view along the line BB of FIG. 4 and generally through the ocular tube 47. The ocular tube 47 has a screw threaded end 69 which receives a screw threaded insert 71. The screw threaded insert 71 has a tapered portion 73 which forms a field stop for limiting the field of view of light passing through the eyepiece 21 so that the field of view has a sharply defined boundary. The insert 71 has a shoulder 75. The lens 51 is formed of a doublet assembly comprises two lenses 51a and 51b with the lens 51b being fitted hard against the shoulder 75 as shown in FIG. 6. A spacer ring 78 is inserted after the lens 51b and within insert 71. The lens 51a is then inserted into the insert 71 and will be spaced slightly apart from the lens 51b by the spacer ring 78. The insert 71 has an external screw thread 80 and an end cap 82 having a flange 83 which carries a screw thread 85 is screw threaded onto the insert 71. The cap 82 has an annular flange 85 which extends over lens 51a so as to hold the lenses 51a and 51b securing within the insert 71. The cap 82 has a central opening 87 so that light passing through the lenses 51a and 51b can be received by a user's eye.

Light from the mirror 57 in FIG. 5 is reflected to the mirror 56 through transverse tube 44 and up from mirror 56 to mirror 55 where upon the light is. reflected through the lens 50, formed by the doublet assembly 50a and 50b to a user's eye.

Thus, by wearing the loupes as shown in FIG. 1 the user is able to have a field of vision which is below the normal sight level when looking straight ahead.

In the preferred embodiment of the invention, in order to minimise eyestrain of a user of the loupes, the oculars 40 are angled with respect to one another so that they converge from a first spacing adjacent an end through which the user looks to smaller spacing remote from that position (ie in a direction away from the user). The oculars 40 are arranged in the required angular orientation by mounting the oculars 40 for movement relative to the sliders 275 so that the angular position of the oculars 40 can be set to suit a particular position and the then oculars 40 locked in place. In order to secure the oculars 40 of eyepiece 21 to a respective slider 275 the oculars can be first angled to the required orientation and then fixed in place by adhesive or the like or, alternatively, the oculars 40 can be fixed to the sliders 275 by nuts and bolts of other suitable fasteners and locked in place once the required angular orientation of the oculars 40 has been set. Generally, the setting of the angular position of the oculars will be performed during calibration or setup of the instrument for use by a particular physician and then will remain fixed. However, if the attachment of the slider 275 to the ocular 40 is by way of nuts or bolts or other releasable fasteners, adjustments can be made at a later date if required.

Alternatively, the oculars 40 could be permanently fixed to the sliders 275 and the sliders 275 could be adjusted to prove the required angulared convergence of the oculars 40.

To minimise eyestrain of a person looking through the loupes it is preferred that the angular convergence of the ocular axis of the oculars be a combined amount of about 3° (as shown in the exaggerated diagram forming FIG. 6A). This angle of convergence matches the natural convergence of the line of sight of a user's eyes when a user is looking at an object spaced from the user by about 1 m. This therefore means that when a person looks through the oculars 40 the person will be looking with a line of sight convergent which matches that which would normally occur when the user is looking at an object about 1 m away. This enables the user's eyes to take up a usual position which greatly reduces eye strain. If the ocular axis of the oculars 40 were parallel with respect to one another users eyes would take up a position which would give a line a sight which is not usual when looking at an object about 1 m away and this will cause some eye strain if the user is required to look through the loupes for a significant amount of time. Furthermore, because the eyes are required to take up such a position it is much more difficult for the user to actually look through the oculars and observe the work area. With the preferred embodiment of the present invention in which the oculars are angled the user can more readily look through the loupes and observe the work area which provides a much greater field of view and one which is much easier to obtain and maintain when the user looks through the loupes.

In order for the field of view of the loupes to converge at a position where the surgeon will be working it is necessary for the objectives 42 to also be angled towards one another (as shown by arrows P and Q in FIG. 6B) so that their axis converges at the point of intended inspection. In order to achieve this the eyepieces 21 are rotated about the ocular axis in directions opposite to one another so as to cause the line of sight through the objectives to converge towards one another. When the required amount of rotation and angular positioning of the eyepieces 21 has been set the eyepieces can then be locked to the sliders 275 by adhesive or by tightening fastening screws or any other suitable manner.

Because the eyepieces 21 are rotated about the ocular axis in order for the objective axis to converge towards one another, the rotation will not change the position of the ocular relative to the eye axis but will cause some slight image rotation. In order to compensate for the image rotation the mirrors 56 and 57 (in the embodiment of FIG. 3) of the transverse tube 44 can be rotated slightly thus cancelling out any rotation of the image which is being caused by proper alignment of the eyepieces 21 during the calibration process.

As previously mentioned, by angling the oculars in the manner referred to above eyestrain is minimised and can possibly be eliminated all together compared to situations where the oculars of binocular optical devices are arranged parallel with respect to one another or have an exaggerated angle of convergence of greater than 5°. Thus, according to the preferred embodiment of the invention the oculars have the optimal convergence to minimise eyestrain.

The light source 38 is powered by a battery (not shown) which is connected to the source 38 by a wire or cable (not shown). The battery may be conveniently worn by the user and the cable draped over the user's shoulder so as to be out of the way to provide power to the light source 38. FIGS. 7 to 12 show schematically three embodiments of a light source used in the present invention.

With reference to FIG. 7 the light source comprises an array of light emitting diodes 100 and a lens array 102 which is spaced from the light emitting surface or diode junction of the diodes 100. The diodes 100 may be white light emitting diode or different coloured light emitting diodes which when combined produce white light. The power supplied to the different coloured light emitting diodes may be controlled to provide light of a particular colour should that be required or desired by powering some of the coloured diodes more highly than others. Alternatively, the diodes may be white or a single colour such as red or blue. In other embodiments most of the diodes could be white with one or two being of a particular colour to fill out deficiencies in the white spectrum of the white diodes. In still a further embodiment diodes may include diodes of all primary colours so that particular colours or combination of colours can be selected as desired.

The array 100 comprises a central diode 102 and six surrounding diodes 103. A separate lens 102a is provided in the array 102 for each of the separate diodes 102 and 103. The light emitting diodes are known and therefore need not be described in detail however, the conventional light emitting diodes are modified by removing the lens from the end of the light emitting diode and by grinding or polishing the end 104 of the light emitting diodes 102 and 103 flat. The result of this is that light appears to come from a more point like source and is spread over a much wider angle. To create a more suitable, narrow angled beam, the lens array 102 is set at a distance from the polished ends 104 of the diodes 102 and 103 with the distance between the array 102 and the diodes 101 and 103 being chosen to provide the desired optical beam profile.

In the preferred embodiment six diodes 103 surround the central diode 101. However, in other embodiments a different number of diodes could surround the central diode 101.

FIG. 8 is a schematic side view of the embodiment of FIG. 7 and shows the light beam that passes through the array 102.

By separating the lens array 102 from the light emitting diodes 100 the light beams from the diodes 101 and 103 overlap one another as shown in FIG. 8 so as to produce illumination over a desired field of view. However, whilst the individual beams are aimed in the same direction there would be a lack of total beam overlap at the beam edges and thus the outer region of the field of view shown in FIG. 8 will be dimmer than the inner region.

FIG. 9 shows a modified embodiment in which like reference numerals indicate like parts of those previously described. In this embodiment the lenses 102a which correspond to the diodes 103 are tilted slightly inwardly towards the beam emanating from the central lens 102a to direct the outer beams towards the central light beam from the diode 101. The displacement of the outer beams through this lens tilt is quite small and uniform illumination over the field of view is provided as shown by FIG. 10. However, it should be understood that the amount of tilt of the lenses 102a should be relatively small and if significant tilt is required then unacceptable vignetting will result.

FIG. 11 and FIG. 12 show a further modification in which the lenses 102a associated with the diodes 103 are displaced inwardly towards the lens 102a associated with the middle diode 101. As can be seen in FIG. 12 the central axes of the lenses marked 102a′ is shifted inwardly compared to the central axis of the light emitting diodes 103. Once again this produces a uniform light illumination over a required field of view as shown by FIG. 12.

FIGS. 13 and 14 show a structural arrangement of the light source 38 in accordance with the teachings of FIGS. 7 to 12. The light source 38 has a mounting body 120 in which the array of light emitting diodes 103 is supported. The diodes 103 may be mounted on a suitable circuit board held by the body 102 and control circuitry and power cabling may enter the body 120 through opening 122. A lens holder 124 is screw threaded onto the body 120 and carries the lens array 102. The lens array 102 may be formed in a single sheet with each lens 102 being formed as a hill or projection within the sheet 102. The individual lenses 102a are preferably configured as per FIGS. 9 and 10 or 11 and 12 so as to provide the uniform field of illumination as disclosed with reference to those Figures.

FIGS. 15 to 18 show further embodiments of the invention which use different number of mirrors to the preferred embodiment described with reference to FIGS. 1 to 6. In FIG. 15 two mirrors 110 and 112 are used. The mirrors 110 and 112 form a “roof” at an angle of 90°. Once again, in the embodiments of FIGS. 15 to 18 the light rays show light from the ocular to the objective rather than in the reverse direction which will be the true way light would pass from a object to be viewed by a user. The embodiment of FIGS. 1 to 6 also includes a “roof” type arrangement which is formed by the mirrors 56 and 57. However in that embodiment, the mirrors are separated from one another whereas in the embodiment of FIG. 15 they are in side by side relationship. Nevertheless, the nature of the reflection and the manner in which the image is attached by the mirrors is the same as that in FIG. 15 and 16. When an object is viewed through the objective 52 the objective inverts, or turns upside-down, the image. The roof arrangement formed by the mirrors 110 and 112 flips the image from side to side and turns the image upside-down so that a true image is viewed through the ocular 50 rather than the inverted image. The image viewed through the embodiment of FIGS. 1 to 6 is flipped from side to side and turned upside-down by the mirrors 56 and 57 in exactly the same manner. The embodiment of FIG. 15 shows how light can be transferred from the objective 42 to the ocular 40. However, the embodiment of FIGS. 15 and 16 has a disadvantage that the mirrors 110 and 112 must be reasonably large. In the embodiments of FIGS. 1 to 6 the four mirrors reduces the angles of reflection which are required and the mirrors can therefore be of much smaller size thereby generally decreasing the overall size of the ocular 40 and objective 42.

FIG. 17 shows a further embodiment in which six mirror are utilised. In the embodiment the light from the objective is reflected by mirror 114 to mirror 115 which in turn is reflected to mirrors 116 and 117 which form a “roof” in the same manner as described with reference to FIG. 15 so that light from the mirror 117 is reflected to mirror 118 and then to mirror 119 and through ocular 50.

FIG. 18 shows a still further embodiment in which eight mirrors are used. In this embodiment light is passed through objective 52 and reflected by a mirror 120 to mirror 121 then to mirror 122 down to “roof” mirrors 123 and 124, then to mirror 125, to mirror 126, then to mirror 127 and through ocular 50. In order to provide a view of an object in front of a user wearing the loupes, generally an even number of mirrors will be required and in order to flip the image from side to side and turn it upside-down so that the inversion created by the objective 52 is corrected, a “roof” mirror configuration of the type described above will be required. However, if it is desired to view an object behind a person using the loupes an odd number of mirrors could be utilised. Whilst applications requiring vision to the rear are by no means as important or apparent as those which require vision in front of the user, the present invention nevertheless can provide for this possibility if needed.

Since modifications within the spirit and scope of the invention may readily be effected by persons skilled within the art, it is to be understood that this invention is not limited to the particular embodiment described by way of example hereinabove.

The claims defining the invention are as follows:

1. Optical loupes, including:
a support means for wearing on a user's head, the support means having two eyepieces, so that when the loupes are worn by a user, the eyepieces are disposed in front of the user's eyes, each eyepiece having:
(a) an objective having an objective axis;
(b) an ocular having an ocular axis, the ocular and the ocular axis being arranged at an obtuse angle with respect to the objective and the objective axis, the objective and the ocular being arranged in side by side relationship; and
(c) light transfer means for transferring light from the objective to the ocular.

2. The loupes of claim 1 wherein the ocular axis and objective axis are in planes spaced apart in the interpupillary direction when the loupes are worn by a user

3. The loupes of claim 1 or claim 2 wherein the light transfer means includes a plurality of mirrors for transferring light from the objective to the ocular.

4. The loupes of claim 3 wherein the light transfer means comprises only mirrors for transferring light from the objective to the ocular.

5. The loupes of claim 1 or 3 wherein the angle is an obtuse angle.

6. The loupes of claim 4 wherein the plurality of mirrors includes at least a first mirror in the objective for reflecting light in a first direction, a second mirror for receiving light from the first mirror and reflecting the light generally in the interpupillary direction, a third mirror for receiving light from the second mirror, and a fourth mirror in the ocular for receiving light from the third mirror and reflecting the light into the ocular.

7. The loupes of claim 6 wherein the second and third mirror form a roof structure for flipping an image from side to side, and wherein the objective includes an objective lens so that an image which is inverted by the objective lens is flipped side by side by the second and third mirrors and upside-down by reflection from the first mirror to the fourth mirror.

8. The loupes of claim 2 wherein the spaced apart planes are substantially parallel vertical planes.

9. The loupes of claim 1 wherein the ocular includes an ocular lens remote from the fourth mirror.

10. The loupes of claim 1 wherein the objective includes an objective lens remote from the first mirror.

11. The loupes of claim 9 wherein the ocular further includes an ocular housing tube which supports the ocular lens and the fourth mirror.

12. The loupes of claim 10 wherein the objective further includes an objective housing tube which supports the objective lens and the first mirror.

13. The loupes of claim 7 wherein the second and third mirrors are arranged in a transverse tube housing communicating with the ocular tube housing and the objective tube housing.

14. The loupes of claim 13 wherein the objective tube housing, ocular tube housing and transverse tube housing are integrally coupled together to form an integral eyepiece housing.

15. The loupes of claim 14 wherein the ocular tube housing includes an insert tube connected to the ocular tube housing which supports the ocular lens, the insert tube having an end stop arranged between the ocular lens and the fourth mirror.

16. The loupes of claim 14 wherein an end cap is arranged on the insert tube, the end cap having an annular flange, the insert having a shoulder and wherein the ocular lens is arranged between the annular flange and the shoulder.

17. The loupes of claim 1 wherein the support means is a frame having a pair of arms and a nose support.

18. The loupes of claim 1 wherein a light source is mounted to the frame between the eyepieces.

19. The loupes of claim 18 wherein the light source comprises an array of light emitting diodes.

20. The loupes of claim 19 wherein the light source includes a power supply for supplying power to the diodes.

21. The loupes of claim 20 wherein the power supply comprises a battery.

22. The loupes of claim 19 wherein the array of light emitting diodes comprises a central diode and at least six diodes surrounding the central diode.

23. The loupes of claim 22 wherein the diodes have individual lenses which are spaced from the diode junction of the diodes.

24. The loupes of claim 23 wherein the lenses associated with the diodes which surround the central diode are tilted so as to face a central axis of the diode array to direct light from the diodes which surround the central diode towards the light beam omitted by the central diode.

25. The loupes of claim 23 wherein the lens associated with the diodes which surround the central diode are displaced towards the lens associated with the central diode.

26. The loupes of claim 9 wherein the ocular lens includes two lenses, and a spacer ring is provided between the two lenses for spacing the two lenses slightly apart.

27. An eyepiece for optical loupes, including:
(a) an objective having an objective axis;
(b) an ocular having an ocular axis, the ocular and the ocular axis being arranged at an angle with respect to the objective and the objective axis, the objective and the ocular being arranged in side by side relationship; and
(c) light transfer means for transferring light from the objective to the ocular, the light transfer means comprising a plurality of mirrors for transferring light from the objective to the ocular.

28. The eyepiece of claim 27 wherein the angle is an obtuse angle.

29. The eyepiece of claim 27 wherein the ocular axis and objective axis are in spaced apart planes.

30. The eyepiece of claim 27 wherein the plurality of mirrors includes at least a first mirror in the objective for reflecting light in a first direction, a second mirror for receiving light from the first mirror, a third mirror for receiving light from the second mirror, and a fourth mirror in the ocular for receiving light from the third mirror and reflecting the light into the ocular.

31. The eyepiece of claim 30 wherein the second and third mirror form a roof structure for flipping an image from side to side, and wherein the objective includes and objective lens so that an image which is inverted by the objective lens is flipped side by side by the second and third mirrors and upside-down by reflection from the first mirror to the fourth mirror.

32. The eyepiece of claim 30 wherein the ocular includes an ocular lens remote from the fourth mirror.

33. The eyepiece of claim 27 wherein the objective includes an objective lens remote from the first mirror.

34. The eyepiece of claim 32 wherein the ocular further includes an ocular housing tube which supports the ocular lens and the fourth mirror.

35. The eyepiece of claim 33 wherein the objective further includes an objective housing tube which supports the objective lens and the first mirror.

36. The eyepiece of claim 28 wherein the second and third mirrors are arranged in a transverse tube housing communicating with the ocular tube housing and the objective tube housing.

37. The eyepiece of claim 36 wherein the objective tube housing, ocular tube housing and transverse tube housing are integrally coupled together to form an integral eyepiece housing.

38. The eyepiece of claim 37 wherein the ocular tube housing includes an insert tube connected to the ocular tube housing which supports the ocular lens, the insert tube having an end stop arranged between the ocular lens and the fourth mirror.

39. The eyepiece of claim 38 wherein an end cap is arranged on the insert tube, the end cap having an annular flange, the insert having a shoulder and wherein the ocular lens is arranged between the annular flange and the shoulder.

40. The eyepiece of claim 32 wherein the ocular lens includes two lenses, and a spacer ring is provided between the two lenses for spacing the two lenses slightly apart.

41. A light source including;
an array of light emitting diodes;
an array of lenses spaced from the light emitting surface of the light emitting diodes for directing light emitted by the light emitting diodes into a field of view.

42. The light source of claim 41 wherein the light emitting diodes emit white light.

43. The light source of claim 41 wherein the array of light emitting diodes comprises a central diode and a plurality of diodes surrounding the central diode.

44. The light source of claim 43 wherein the plurality of diodes surrounding the central diodes comprise six diodes.

45. The light source of claim 41 wherein the array of lenses includes a separate lens for each diode in the light emitting diode.

46. The light source of claim 41 wherein the lenses associated with the diodes surrounding the central diode are tilted towards a central axis of the array of lenses to direct light from the diodes surrounding the central diode towards the light beam emitted by the central diode.

47. The light source of claim 41 wherein the lenses associated with the diodes surrounding the central diode are displaced towards the lens associated with the central diode so as to direct light towards the light beam of the central diode.

48. Optical loupes, including:
a frame for wearing on a user's head, the frame supporting two eyepieces so that when the loupes are worn by a user, the eyepieces are disposed in front of a user's eye, each eyepiece having;
an objective, and an ocular arranged at an angle with respect to the objective, so that when looking through the eyepieces a field of view is provided different to that which would be provided if looking only through the ocular;
a light source coupled to the frame for illuminating the field of view of the loupes, the light source including an array of light emitting diodes.

49. The loupes of claim 48 wherein the array of light emitting diodes have an array of lenses spaced from the light emitting surface of the light emitting diodes.

50. The loupes of claim 48 wherein the array of light emitting diodes comprises a central diode and a plurality of diodes surrounding the central diode.

51. The loupes of claim 50 wherein the plurality of diodes surrounding the central diodes comprise six diodes.

52. The loupes of claim 49 wherein the array of lenses includes a separate lens for each diode in the light emitting diode.

53. The loupes of claim 49 wherein the lenses associated with the diodes surrounding the central diode are tilted towards a central axis of the array of lenses to direct light from the diodes surrounding the central diode towards the light beam emitted by the central diode.

54. The loupes of claim 49 wherein the lenses associated with the diodes surrounding the central diode are displaced towards the lens associated with the central diode so as to direct light towards the light beam of the central diode.

55. Optical loupes, including;
a frame for wearing on a user's head, the frame supporting two eyepieces so that when the loupes are worn by a user, the eyepieces are disposed in front of a user's eye;
distance adjusting means for adjusting the distance between the eyepieces in the interpupillary direction, the distance adjusting means including;
(a) a slider coupled to at least one of the eyepieces;
(b) an adjustment knob coupled to the slider;
(c) a pinion gear fixed relative to the knob for rotation with the knob;
(d) a rack engaged with the pinion gear and fixed relative to the frame and, wherein when the knob is rotated the pinion is also rotated so that engagement between the pinion and rack causes movement of the knob, pinion and slider relative to the frame in the interpupillary direction so as to enable adjustment of said at least one eyepiece in the interpupillary direction.

56. The loupes of claim 55 wherein a locking screw is supported in the pinion and in engagement with the slider so as to clamp the slider relative to the frame and selectively release the slider from the frame to enable the slider to move relative to the frame to adjust the interpupillary distance between the eyepieces.

57. The loupes of claim 55 wherein the frame includes an interpupillary adjustment bar having at least one slot, the locking screw projecting through the slot and into the slider arranged below the slot so as to couple the adjustment knob and the pinion gear to the slider.

58. The loupes of claim 57 wherein a screw thread is provided between the shaft of the screw and a bore in the slider for coupling the locking screw to the slider.

59. The loupes of claim 57 wherein upon locking rotation of the locking screw, the slider is drawn against the bar to lock the slider fixed relative to the frame and upon loosening of the locking screw the slider is able to slide relative to the bar.

60. The loupes of claim 55 wherein each of the eyepieces includes a said adjusting means.

61. An optical instrument including;
a first eyepiece and a second eyepiece through which a user of the instrument will look in order to observe an object;
the first and second eyepieces including an ocular each having an axis; and
the axes of the oculars being arranged such that the axes converge towards one another from a spacing of greatest dimension adjacent an end of the ocular through which a user looks to observe the object, towards an end of the ocular remote from the end adjacent the user, the amount of convergence being substantially the same as the convergence of the field of view of a user observing an object spaced from the observer by a distance of about 1 m.

62. The instrument of claim 61 wherein the angle of convergence is between 2° and 5°.

63. The instrument of claim 62 wherein the angle is 3°.

64. The instrument of claim 61 wherein the optical instruments includes an objective having an objective axis, the axis of the objective being arranged at an angle with respect to the axis of the ocular.

65. The instrument of claim 64 wherein the objective and ocular are arranged in side by side relationship.

66. The instrument of claim 65 wherein the optical instrument includes light transfer means for transferring light from the objective to the ocular.

67. The instrument of claim 61 wherein the light transfer means comprises mirrors.

68. The instrument of claim 64 wherein the objectives are arranged at an angle with respect to one another by rotating each eyepiece about the ocular axis so as to cause the objective axes to converge to a point coincident with the field of view which is desired through the optical instrument.

69. The instrument of claim 68 wherein a transverse axis extends between the ocular and the objective along which light is reflected so as to transfer light from the objective to the ocular, the transfer axis including at least two mirrors, and the two mirrors being rotated slightly in order to cancel out any rotation of the image caused by rotation of the eyepieces about the ocular axis so as to cause the objectives to converge towards one another.
